(19) United States
(12) Patent Application Publication
(10) Pub. No.: US 2026/0102993 A1
(43) Pub. Date: Apr. 16, 2026

(54) ELECTRICALLY INSULATING LAMINATES FOR ELECTRIC MACHINE APPLICATIONS

(71) Applicants: DUPONT ELECTRONICS, INC., WILMIGTON, DE (US); DUPONT SAFETY & CONSTRUCTION, INC., WILMINGTON, DE (US)

(72) Inventors: MARTINO BAILONI, MILANO (IT); CHRISTOPHER JAY DEMBROSKY, RICHMOND, VA (US); BENJAMIN GAUSSENS, MEYRIN (CH); ERIC OLIVIER KANICKI, ALPHARETTA, GA (US); MICHAEL F MULZER, CIRCLEVILLE, OH (US); GIORGIO VERCESI, MEYRIN (CH)

(21) Appl. No.: 19/233,151

(22) Filed: Jun. 10, 2025

Related U.S. Application Data
(60) Provisional application No. 63/662,554, filed on Jun. 21, 2024.

(51) Int. Cl. B32B 27/12; B32B 5/02; B32B 27/28

(52) U.S. Cl. CPC B32B 27/12; B32B 5/022; B32B 5/024; B32B 27/281; B32B 2250/02; B32B 2262/0269; B32B 2307/206

(57) ABSTRACT

In a first aspect, an electrically insulating laminate includes a flexible polymer layer having a first thermoplastic polyimide having a glass transition temperature (T_{g}) in a range of from 140 to 280° C. and a first flexible mat layer having a first organic material. The first organic material includes a woven, a non-woven or a fiber. The flexible polymer layer is thermally bonded and in direct contact with the first organic material. In a second aspect, an electric machine includes the electrically insulating laminate of the first aspect.

### FIELD OF DISCLOSURE

The field of this disclosure is electrically insulating laminates for electric machine applications.

### BACKGROUND OF THE DISCLOSURE

Slot liners are used in the stators and/or rotors of electric machines, such as generators and/or motors, to provide insulation between the stator core and/or rotor core and the stator windings and/or rotor windings. The slot liner will similarly separate rotor windings from the rotor core.

Stator design constraints include stator laminations, magnet wire, slot insulation and thermal management.

Common slot liner materials consist of multilayer structures bonded together by a glue or adhesive. Typically, a core layer is surrounded by two outer layers of a different kind of material and adhered to them by use of additional layers of an adhesive applied between the core layer and the outer layers. Adhesives include polyurethane, acrylic, epoxy resin and silicon chemistries.

In the case of an electrically insulating laminate structure where the outer layer is removed from the core layer through physical force alone, e.g., through a peeling process, the typical mode of material failure observed is an adhesive failure at the interface between the adhesive and the adherend. This is not a desirable mode of failure. A more preferred mode of failure is a cohesive failure which occurs in the bulk layers of either the adhesive or sometimes in the bulk of one of the adherends (i.e., the materials being bonded).

Good adhesion performance is critical, especially in the use of high temperature electric motors, where the exposure to temperature is coupled with exposure of the laminate material to chemicals (such as automatic transmission fluid) which may contain contaminates that can degrade typical adhesive formulations due to their low glass transition temperature (T_{g}) or incompatibility with other chemicals. In the event of delamination occurring in the slot liner material during the lifetime of the electric machine, fast switching inverters will build accumulate charges and reduce the effective partial discharge peak voltage of the electrical insulation system. Additionally, there is a risk of unintentionally introducing voids into the adhesive layer as it is applied due to entrapment of air during the coating process, thus introducing voids that could initiate corona discharge or breakdown of the adhesive material when exposed to high electric fields. Therefore, the use of a chemically, electrically and thermally stable insulation design is in the best interest of OEMs to guarantee reliability of the machine. One way to achieve this is by using a slot liner material that does not incorporate adhesive layers between the adherends. An additional benefit of the elimination of adhesive layers is an overall thinner slot liner material construction without degrading any desired performance properties of the slot liner material because the presence of adhesive layers usually adds about 1 mil thickness to the overall slot liner material laminate.

Previous efforts to eliminate the use of adhesives in slot liner laminate materials while using a polyimide material as a core have been described in U.S. Pat. Nos. 10,173,403 B2 and 10,836,112 B2 and U.S. Patent Application No. 2012/0128988 A1, which describe plasma treating the surfaces of the materials to be adhered and then joining them together through the application of temperature and pressure. However, this approach requires additional material processing steps which add complexity and cost. Additionally, U.S. Pat. No. 10,836,112 B2 describes laminating polyimide film and aramid paper together in the absence of adhesives by applying high temperature and pressure. However, the strength of adhesion between the individual layers in the resulting laminate is only described qualitatively and therefore leaves it uncertain if the laminates would survive subsequent processing steps such as folding.

### DETAILED DESCRIPTION

In a first aspect, an electrically insulating laminate includes a flexible polymer layer having a first thermoplastic polyimide having a glass transition temperature (T_{g}) in a range of from 140 to 280° C. and a first flexible mat layer having a first organic material. The first organic material includes a woven, a non-woven or a fiber. The flexible polymer layer is thermally bonded and in direct contact with the first organic material.

In a second aspect, an electric machine includes the electrically insulating laminate of the first aspect.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

As used herein, an “aromatic diamine” is intended to mean a diamine having at least one aromatic ring, either alone (i.e., a substituted or unsubstituted, functionalized or unfunctionalized benzene or similar-type aromatic ring) or connected to another (aromatic or aliphatic) ring, and such an amine is to be deemed aromatic, regardless of any non-aromatic moieties that might also be a component of the diamine. Hence, an aromatic diamine backbone chain segment is intended to mean at least one aromatic moiety between two adjacent imide linkages. As used herein, an “aliphatic diamine” is intended to mean any organic diamine that does not meet the definition of an aromatic diamine.

Depending upon context, “diamine” as used herein is intended to mean: (i) the unreacted form (i.e., a diamine monomer); (ii) a partially reacted form (i.e., the portion or portions of an oligomer or other polyimide precursor derived from or otherwise attributable to diamine monomer) or (iii) a fully reacted form (the portion or portions of the polyimide derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate polyamic acid (which can then be cured into a polyimide). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polyimide composition reacted from or otherwise attributable to dianhydride monomer) or (iii) a fully reacted form (the portion or portions of the polyimide derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polyimide). Such additional anhydride moieties could be used to crosslink the polymer or to provide other functionality to the polymer.

Any one of a number of polymer manufacturing processes may be used to prepare polymer films. It would be impossible to discuss or describe all possible polymer manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways by those of ordinarily skilled in the art, using any conventional or non-conventional polymer manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

### Organic Solvents

Useful organic solvents for the synthesis of the polymers of the present invention are preferably capable of dissolving the polymer precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), N,N-dimethylacetamide (DMAc), methyl ethyl ketone (MEK), N,N-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and N,N-dimethylacetamide (DMAc).

### Diamines

In one embodiment, a suitable diamine for forming the polymer film can include an aliphatic diamine, such as 1,2-diaminoethane, 1,6-diaminohexane (HMD), 1,4-diaminobutane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, isophoronediamine, bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility are maintained. Long chain aliphatic diamines increase flexibility.

In one embodiment, a suitable diamine for forming the polymer film can further include a fluorinated aromatic diamine, such as 2,2′-bis(trifluoromethyl)benzidine (TFMB), trifluoromethyl-2,4-diaminobenzene, trifluoromethyl-3,5-diaminobenzene, 2,2′-bis-(4-aminophenyl)-hexafluoro propane, 4,4′-diamino-2,2′-trifluoromethyl diphenyloxide, 3,3′-diamino-5,5′-trifluoromethyl diphenyloxide, 9.9′-bis(4-aminophenyl) fluorene, 4,4′-trifluoromethyl-2,2′-diaminobiphenyl, 4,4′-oxy-bis-[2-trifluoromethyl)benzene amine](1,2,4-OBABTF), 4,4′-oxy-bis-[3-trifluoromethyl)benzene amine], 4,4′-thio-bis-[(2-trifluoromethyl)benzene-amine], 4,4′-thiobis[(3-trifluoromethyl)benzene amine], 4,4′-sulfoxyl-bis-[(2-trifluoromethyl)benzene amine, 4,4′-sulfoxyl-bis-[(3-trifluoromethyl)benzene amine], 4,4′-keto-bis-[(2-trifluoromethyl)benzene amine], 1,1-bis[4′-(4″-amino-2″-trifluoromethylphenoxy)phenyl]cyclopentane, 1,1-bis[4′-(4″-amino-2″-trifluoromethylphenoxy)phenyl]cyclohexane, 2-trifluoromethyl-4,4′-diaminodiphenyl ether; 1,4-(2′-trifluoromethyl-4′,4″-diaminodiphenoxy)-benzene, 1,4-bis(4′-aminophenoxy)-2-[(3′,5′-ditrifluoromethyl)phenyl]benzene, 1,4-bis[2′-cyano-3′ (″4-amino phenoxy) phenoxy]-2-[(3′,5′-ditrifluoro-methyl)phenyl]benzene (6FC-diaminc), 3,5-diamino-4-methyl-2′,3′,5′,6′-tetrafluoro-4′-tri-fluoromethyldiphenyloxide, 2,2-Bis[4′ (4″-aminophenoxy)phenyl]phthalein-3′,5′-bis(trifluoromethyl) anilide (6FADAP) and 3,3′,5,5′-tetrafluoro-4,4′-diamino-diphenylmethane (TFDAM). In a specific embodiment, the fluorinated diamine is 2,2′-bis(trifluoromethyl)benzidine (TFMB). In one embodiment, a fluorinated aromatic diamine can be present in a range of from 40 to 95 mole percent, based on the total diamine content of the polyimide. In a more specific embodiment, the fluorinated aromatic diamine can be present in a range of from 50 to 75 mole percent, based on the total diamine content of the polyimide.

In one embodiment, any number of additional diamines can be used in forming the polymer film, including p-phenylenediamine (PPD), m-phenylenediamine (MPD), 2,5-dimethyl-1,4-diaminobenzene, 2,5-dimethyl-1,4-phenylenediamine (DPX), 2,2-bis-(4-aminophenyl) propane, 1,4-naphthalenediamine, 1,5-naphthalenediamine, 4,4′-diaminobiphenyl, 4,4″-diamino terphenyl, 4,4′-diamino benzanilide, 4,4′-diaminophenyl benzoate, 4,4′-diaminobenzophenone, 4,4′-diaminodiphenylmethane (MDA), 4,4′-diaminodiphenyl sulfide, 4,4′-diaminodiphenyl sulfone, 3,3′-diaminodiphenyl sulfone, bis-(4-(4-aminophenoxy)phenyl sulfone (BAPS), 4,4′-bis-(aminophenoxy) biphenyl (BAPB), 4,4′-diaminodiphenyl ether (ODA), 3,4′-diaminodiphenyl ether, 4,4′-diaminobenzophenonc, 4,4′-isopropylidenedianiline, 2,2′-bis-(3-aminophenyl) propanc, N,N-bis-(4-aminophenyl)-n-butylamine, N,N-bis-(4-aminophenyl)methylamine, 1,5-diaminonaphthalene, 3,3′-dimethyl-4,4′-diaminobiphenyl, m-amino benzoyl-p-amino anilide, 4-aminophenyl-3-aminobenzoate, N,N-bis-(4-aminophenyl) aniline, 2,4-diaminotoluene, 2,5-diaminotoluene, 2,6-diaminotoluene, 2,4-diamine-5-chlorotoluene, 2,4-diamine-6-chlorotoluene, 2,4-bis-(beta-amino-t-butyl) toluene, bis-(p-beta-amino-t-butyl phenyl) ether, p-bis-2-(2-methyl-4-aminopentyl)benzene, m-xylylene diamine, and p-xylylene diamine.

Other useful diamines include 1,2-bis-(4-aminophenoxy)benzene, 1,3-bis-(4-aminophenoxy)benzene (RODA), 1,2-bis-(3-aminophenoxy)benzene, 1,3-bis-(3-aminophenoxy) benzene, 1-(4-aminophenoxy)-3-(3-aminophenoxy)benzene, 1,4-bis-(4-aminophenoxy)benzene, 1,4-bis-(3-aminophenoxy)benzene, 1-(4-aminophenoxy)-4-(3-aminophenoxy)benzene, 2,2-bis-(4-[4-aminophenoxy]phenyl) propane (BAPP), 2,2′-bis-(4-phenoxy aniline) isopropylidene, 2,4,6-trimethyl-1,3-diaminobenzene and 2,4,6-trimethyl-1,3-diaminobenzene.

Diamines which can be used in the polymer film include the following: meta-phenylenediamine; para-phenylenediamine; 2,2-bis(4-aminophenyl) propane; 4,4′-diaminodiphenylmethane; 4,4′-diaminodiphenyl sulfide; 4,4′-diaminodiphenyl sulfone; 3,3′-diaminodiphenyl sulfone; 4,4′-diaminodiphenyl ether; 2,6-diaminopyridine; bis(3-aminophenyl) diethyl silane; benzidine; 3,3′-dichlorobenzidine; 3,3′-dimethoxybenzidine; 4,4′-diaminobenzophenone; N,N-bis(4-aminophenyl)-n-butylamine; N,N-bis(4-aminophenyl)methylamine; 1,5-diaminonaphthalene; 3,3′-dimethyl-4,4′-diaminobiphenyl; m-aminobenzoyl-p-aminoanilide; 4-aminophenyl-3-aminobenzoate; N,N-bis(4-aminophenyl) aniline; 2,4-bis(beta-amino-t-butyl) toluene; bis(p-beta-amino-t-butylphenyl) ether; p-bis-2-(2-methyl-4-aminopentyl)benzene; p-bis(1,1-dimethyl-5-aminopentyl)benzene; m-xylylenediamine; p-xylylenediamine; position isomers of the above, and mixtures thereof.

### Dianhydrides

In one embodiment, any number of suitable dianhydrides can be used in forming the polymer film. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable dianhydrides include 3,3′,4,4′-biphenyl tetracarboxylic dianhydride (BPDA), 1,2,5,6-naphthalene tetracarboxylic dianhydride, 1,4,5,8-naphthalene tetracarboxylic dianhydride, 2,3,6,7-naphthalene tetracarboxylic dianhydride, 2-(3′,4′-dicarboxyphenyl) 5,6-dicarboxybenzimidazole dianhydride, 2-(3′,4′-dicarboxyphenyl) 5,6-dicarboxybenzoxazole dianhydride, 2-(3′,4′-dicarboxyphenyl) 5,6-dicarboxybenzothiazole dianhydride, 2,2′,3,3′-benzophenone tetracarboxylic dianhydride, 2,3,3′,4′-benzophenone tetracarboxylic dianhydride, 3,3′,4,4′-benzophenone tetracarboxylic dianhydride (BTDA), 2,2′,3,3′-biphenyl tetracarboxylic dianhydride, 2,3,3′,4′-biphenyl tetracarboxylic dianhydride, bicyclo-[2,2,2]-octen-(7)-2,3,5,6-tetracarboxylic-2,3,5,6-dianhydride, 4,4′-thio-diphthalic anhydride, bis(3,4-dicarboxyphenyl) sulfone dianhydride, bis(3,4-dicarboxyphenyl) sulfoxide dianhydride (DSDA), bis(3,4-dicarboxyphenyl oxadiazole-1,3,4) p-phenylene dianhydride, bis(3,4-dicarboxyphenyl) 2,5-oxadiazole 1,3,4-dianhydride, bis 2,5-(3′,4′-dicarboxydiphenylether) 1,3,4-oxadiazole dianhydride, 4,4′-oxydiphthalic anhydride (ODPA), bis(3,4-dicarboxyphenyl) thio ether dianhydride, bisphenol A dianhydride (BPADA), bisphenol S dianhydride, bis-1,3-isobenzofurandione, 1,4-bis(4,4′-oxyphthalic anhydride) benzene, bis(3,4-dicarboxyphenyl) methane dianhydride, cyclopentadienyl tetracarboxylic acid dianhydride, cyclopentane tetracarboxylic dianhydride, ethylene tetracarboxylic acid dianhydride, perylene 3,4,9,10-tetracarboxylic dianhydride, pyromellitic dianhydride (PMDA), tetrahydrofuran tetracarboxylic dianhydride, 1,3-bis-(4,4′-oxydiphthalic anhydride) benzene, 2,2-bis(3,4-dicarboxyphenyl) propane dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, a suitable dianhydride can include an alicyclic dianhydride, such as cyclobutane diandydride (CBDA), cyclohexane dianhydride, 1,2,3,4-cyclopentanetetracarboxylic dianhydride (CPDA), hexahydro-4,8-cthano-1H,3H-benzo[1,2-c: 4,5-c′]difuran-1,3,5,7-tetrone (BODA), 3-(carboxymethyl)-1,2,4-cyclopentanetricarboxylic acid 1,4:2,3-dianhydride (TCA) and meso-butane-1,2,3,4-tetracarboxylic acid dianhydride.

In one embodiment, a suitable dianhydride for forming the polymer film can include a fluorinated dianhydride, such as 4,4′-(hexafluoroisopropylidene)diphthalic anhydride (6FDA) and 9,9-bis (trifuoromethyl)-2,3,6,7-xanthene tetracarboxylic dianhydride. In a specific embodiment, the fluorinated dianhydride is 4,4′-(hexafluoroisopropylidene)diphthalic anhydride (6FDA).

Dianhydrides which can be used in the polymer film include the following: pyromellitic dianhydride; 3,4,9,10-perylene tetracarboxylic dianhydride; naphthalene-2,3,6,7-tetracarboxylic dianhydride; naphthalene-1,4,5,8-tetracarboxylic dianhydride; bis(3,4-dicarboxyphenyl) ether dianhydride; bis(3,4-dicarboxyphenyl) sulfone dianhydride; 2,3,2′,3′-benzophenonetetracarboxylic dianhydride; bis(3,4-dicarboxyphenyl) sulfide dianhydride; bis(3,4-dicarboxyphenyl) methane dianhydride; 2,2-bis(3,4-dicarboxyphenyl) propane dianhydride; 2,2-bis(3,4-dicarboxyphenyl) hexafluoropropane; 3,4,3′,4′-biphenyltetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-1,8,9,10-tetracarboxylic dianhydride; pyrazine-2,3,5,6-tetracarboxylic dianhydride; benzene-1,2,3,4-tetracarboxylic dianhydride; and thiophene-2,3,4,5-tetracarboxylic dianhydride.

### Polymer Film

In one embodiment, a polymer film or layer can have a dielectric constant in a range of from 3.0 to 4.5, when measured at 1 MHz following the procedure described in IPC-TM-650 2.5.5.3. In one embodiment, a polymer film can have coefficient of thermal expansion (CTE) in the XY-axis in a range of from 10 to 75 ppm/° C., when measured over a temperature range of 50 to 250° C. following the procedure described in IPC-TM-650 2.4.41. In one embodiment, a polymer film can have a dielectric strength in a range of from 3000 to 7000 V/mil, when measured following the procedure described in ASTM D149. In one embodiment, a polymer film has a thermal class H rating. In one embodiment, the polymer film has one or more of the aforementioned properties but includes two, three, or more polymer layers.

Polymer films can be plasma-treated by passing through an inner electrode type low-temperature plasma treatment apparatus described in Japanese Patent No. 4607826 B2. The composition ratio of the number of oxygen atoms (O) to the number of carbon atoms (C) in the plasma-treated surface of the material exceeds 150% relative to the theoretical value of the ratio of the numbers of the atoms before treatment. Methods to determine the composition ratio of the number of oxygen atoms (O) to the number of carbon atoms (C) in the surface of the material include X-ray Photoelectron Spectroscopy (XPS).

### Flexible Polymer Layers

In one embodiment, a flexible polymer layer includes a thermoplastic polymer having a glass transition temperature (T_{g}) in a range of from 140 to 280° C. Methods suitable to determine T_{g} include use of dynamic mechanical analysis (DMA) as described in, for example, ASTM E1640 or IPC-TM-650. In one embodiment, a thermoplastic polymer having a T_{g} in a range of from 140 to 280° C. can include a polyimide, a polyamide, a polycarbonate, a polyester, a polysulfone, a poly(amide-imide), a poly(ether-imide), a poly(ether-sulfone), a poly(ether-ether-sulfone), a poly(phenyl-sulfone), a bisphenol A polysulfone, a poly(ether-ketone), a poly(ether-ether-ketone), a poly((1,4-phenyleneoxy-1,4-phenylenecarbonyl-1,4-phenylenecarbonyl), a poly-para-phenylene copolymer, a self-reinforced polyphenylene, a perfluorosulfonic acid ionomer or a cyclic olefin copolymer.

In one embodiment, a flexible polymer layer includes a polyimide film layer. In a more specific embodiment, the flexible polymer layer includes a thermoplastic polyimide film layer. Polyimide film layers according to the present invention can be produced by combining the diamine and dianhydride (monomer or other polyimide precursor form) together with a solvent to form a polyamic acid (also called a polyamide acid) solution. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid casting solution is derived from the polyamic acid solution. The polyamic acid casting solution preferably comprises the polyamic acid solution and can optionally be combined with conversion chemicals like: i.) one or more dehydrating agents, such as, aliphatic acid anhydrides (acetic anhydride, etc.) and/or aromatic acid anhydrides; and ii.) one or more catalysts, such as, aliphatic tertiary amines (triethyl amine, etc.), aromatic tertiary amines (dimethyl aniline, etc.) and heterocyclic tertiary amines (pyridine, picoline, isoquinoline, etc.). The anhydride dehydrating material it is often used in molar excess compared to the amount of amide acid groups in the polyamic acid. The amount of acetic anhydride used is typically about 2.0-4.0 moles per equivalent (repeat unit) of polyamic acid. Generally, a comparable amount of tertiary amine catalyst is used.

In one embodiment, the polyamic acid solution, and/or the polyamic acid casting solution, is dissolved in an organic solvent at a concentration from about 5.0 or 10% to about 15, 20, 25, 30, 35 or 40% by weight.

The polyamic acid (and casting solution) can further comprise any one of a number of additives, such as processing aids (e.g., oligomers), antioxidants, light stabilizers, flame retardant additives, anti-static agents, heat stabilizers, ultraviolet absorbing agents, (organic or inorganic) fillers or various reinforcing agents. Fillers can include inorganic fillers such as thermally conductive fillers, a corona resistant composite filler, and electrically conductive fillers like metals, graphitic carbon and carbon fibers, and electrically conductive polymers. Common inorganic fillers are alumina, silica, silicon carbide, diamond, clay, boron nitride, aluminum nitride, aluminum oxide, titanium dioxide, dicalcium phosphate, and fumed metal oxides. Common organic fillers include polyaniline, polythiophene, polypyrrole, polyphenylenevinylene, polydialkylfluorenes, carbon black, graphite, multiwalled and single walled carbon nanotubes and carbon nanofibers.

Suitable thermally conductive fillers that are also electrically insulating include BN, AlN, Al₂O₃, Si₃N₄, ZnO, MgCO₃, MgO, BeO, diamond, SiC, many other oxide, nitride and carbide compounds and mixtures thereof. These thermally conductive fillers can be of any shape or size and can have an average primary particle size (D₅₀) in a range of from about 0.001 to about 8 μm. In one embodiment, a flexible polymer layer containing thermally conductive fillers has a thermal conductivity of 0.4 W/mK or greater, or 0.6 W/mK or greater, when measuring thermal conductivity according to the method described in ASTM D5470.

In one embodiment, a corona resistant composite filler can have an organic component and an inorganic ceramic oxide component, wherein a weight ratio of the organic component to the inorganic ceramic oxide component is from 0.01:1 to 1:1. In some embodiments, the weight ratio of the organic component to the inorganic ceramic oxide component can be in a range between (and optionally including) any two of the following numbers: 0.01:1, 0.05:1, 0.1:1, 0.2:1, 0.3:1, 0.4:1, 0.5:1, 0.6:1, 0.7:1, 0.8:1, 0.9:1 and 1:1. In one embodiment, at least a portion of the organic component can include an organo-siloxane moiety or an organo-metaloxane moiety (e.g., organozirconate, organotitanate, organoaluminate). In one embodiment, the inorganic ceramic oxide component can include silica, alumina, titania, zirconia or mixtures thereof. In one embodiment, the inorganic ceramic oxide component includes silica, alumina or a mixture thereof. In one embodiment, the inorganic ceramic oxide component is fumed alumina. In one embodiment, the organic component of the corona resistant composite filler material is chosen primarily to provide or improve dispersability of the corona resistant composite filler material into a particular solvated polymer matrix or polymer matrix precursor. In some embodiments, the organic component of the corona resistant composite filler material is chosen to reduce the moisture absorption on the inorganic ceramic oxide component. Ordinary skill and experimentation may be necessary in optimizing the organic component for any particular solvent system selected. In some embodiments, the organo-siloxane moiety is n-octyl silane, or any of its structural isomers. In some embodiments, the corona resistant composite filler is an inorganic ceramic oxide without an organic component. In another embodiment, the organic component is a coating on the inorganic ceramic oxide component. The organic component may or may not cover the entire surface of the inorganic ceramic oxide component. In one embodiment, the electrically insulative, corona resistant composite filler is present in an amount between and including any two of the following numbers: 5, 10, 15, 20, 25 and 30 weight percent, based upon the total weight of the polymer film. In one embodiment, the corona resistant composite filler is present in an amount in a range of from 5 to 30, 5 to 25 or 5 to 20 weight percent, based upon the total weight of the polymer film. In one embodiment, the corona resistant composite filler can have a median particle size of from 0.1 to 5 μm, wherein at least 80, 85, 90, 92, 94, 95, 96, 98, 99 or 100 percent of the dispersed corona resistant composite filler is within the above defined size range. Median particle size can be measured using a Horiba LA-930 particle size analyzer (Horiba Instruments, Inc., Irvine, CA). DMAc can be used as the carrier fluid. In some embodiments, the corona resistant composite filler is a nanofiller. The term “nanofiller” is intended to mean a filler with at least one dimension less than 1000 nm, i.e., less than 1 μm.

In one embodiment, a filler is dispersed or suspended in a polar, aprotic solvent such as DMAc or any other solvent or mixture of solvents compatible with polyamic acid. In one embodiment, the filler can be dispersed in an organic solvent at a concentration from about 5, 10 or 15% to about 20, 30, 40, 50 and 75% by weight. In one embodiment, the solvent used for the dispersion or suspension of the filler is the same or different as the solvent used for the polyamic acid solution. The dispersion or suspension of filler can then be added to the polyamic acid casting solution to achieve the desired filler loading of the final film. The filler may be added by using any commonly used technique such as batch mixing using solvent(s), dry mixing, or continuous mixing using solvent(s). Parameters such as order of raw material addition, mixing speed, shear rate, type of mixing blade (e.g., shear blade), mixing time, temperature, and pressure are known to affect the final degree of mixing between the filler and the matrix material. In one embodiment, blending of the filler slurry with a polyamic acid solution to form the filled polyamic acid casting solution is done using high shear mixing. In one embodiment, the first outer layer in case of a multilayer film can contain filler in an amount of from greater than 0 to about 50 wt % of the dry film. In one embodiment, the core layer in case of a multilayer film can contain filler in an amount of from greater than 0 to about 60 wt % of the dry film. In one embodiment, the second outer layer in case of a multilayer film can contain filler in an amount of from greater than 0 to about 50 wt % of the dry film. In one embodiment, the first outer layer, the core layer and the second outer layer can each have the same or different amount of filler, based on weight percentage of the dry film, as the other layers in the multilayer film. In one embodiment, the weight percentage of filler in the core layer can be higher than that of the first outer layer, the second outer layer, or both the first and second outer layers. In another embodiment, the weight percentage of filler in the core layer can be lower than that of the first outer layer, the second outer layer, or both the first and second outer layers. In another embodiment, in case of a multilayer film only the core layer contains a filler or, conversely, only the outer layers contain a filler. In one embodiment, the presence of a filler in the flexible polymer layer leads to an improvement in failure time in a voltage endurance test relative to a flexible polymer layer of comparative thickness that does not contain a substantial amount of filler when testing for voltage endurance following the method described in ASTM D2275. The amount of filler present in a given layer can be determined using, for example, ash testing or thermogravimetric analysis (TGA). The chemical identity of a filler can be determined, for example, by mechanical preparation of cross sections together with microscopy-assisted optical evaluation using, for example, a scanning electron microscope using energy-dispersive X-ray (EDX) analysis.

The solvated mixture (the polyamic acid casting solution optionally also containing a filler) can then be cast or applied onto a support, such as an endless belt or rotating drum, to give a film. Next, the solvent-containing film can be converted into a self-supporting film by heating at an appropriate temperature (thermal curing) together with conversion chemical reactants (chemical curing). The film can then be separated from the support, oriented such as by tentering, with continued thermal and chemical curing to provide a polyimide film.

Useful methods for producing polyimide film in accordance with the present invention can be found in U.S. Pat. Nos. 5,166,308 A and 5,298,331 A, which are incorporate by reference into this specification for all teachings therein. Numerous variations are also possible, such as,
(a) A method wherein the diamine components and dianhydride components are preliminarily mixed together and then the mixture is added in portions to a solvent while stirring.
(b) A method wherein a solvent is added to a stirring mixture of diamine and dianhydride components. (contrary to (a) above)
(c) A method wherein diamines are exclusively dissolved in a solvent and then dianhydrides are added thereto at such a ratio as allowing to control the reaction rate.
(d) A method wherein the dianhydride components are exclusively dissolved in a solvent and then amine components are added thereto at such a ratio to allow control of the reaction rate.
(e) A method wherein the diamine components and the dianhydride components are separately dissolved in solvents and then these solutions are mixed in a reactor.
(f) A method wherein the polyamic acid with excessive amine component and another polyamic acid with excessive dianhydride component are preliminarily formed and then reacted with each other in a reactor, particularly in such a way as to create a non-random or block copolymer.
(g) A method wherein a specific portion of the amine components and the dianhydride components are first reacted and then the residual diamine components are reacted, or vice versa.
(h) A method wherein the conversion chemicals are mixed with the polyamic acid to form a polyamic acid casting solution and then cast to form a gel film.
(i) A method wherein the components are added in part or in whole in any order to either part or whole of the solvent, also where part or all of any component can be added as a solution in part or all of the solvent.
(j) A method of first reacting one of the dianhydride components with one of the diamine components giving a first polyamic acid. Then reacting the other dianhydride component with the other amine component to give a second polyamic acid. Then combining the amic acids in any one of a number of ways prior to film formation.

The polymer film layer can comprise more than one layer, wherein one or multiple polymer layers are placed on top of a first layer. The composition and thickness of each layer is chosen independently from one another and can be the same or different. Consequently, the mechanical, thermal, and optical properties of an individual layer in a multilayer polymer film can be the same or different relative to the other surrounding layers. In one embodiment, the multilayer film has at least two polymer layers. In another embodiment, the multilayer film has less than ten layers. In one embodiment, the multilayer polymer film comprises at least one core layer and two thermoplastic polymer layers. In a specific embodiment, the outermost layers in a multilayer polymer film with at least two layers are thermoplastic polymer layers. In one embodiment, the polymer in each of the layers is a polyimide. In a more specific embodiment, the outermost layers in a multilayer polyimide film with at least three layers are thermoplastic polyimide layers in addition to a core polyimide layer as an inner layer. In the case of multilayer polyimide films, the T_{g} of the core layer is higher than the T_{g} of the thermoplastic polyimide layer.

The thickness of each polymer layer may be adjusted, depending on the intended purpose of the film or final application specifications. In one embodiment, the multilayer film has a total thickness of from about 5 to about 150 μm. In one embodiment, the multilayer film has a total thickness of from about 5 to about 75 μm. In one embodiment, the thickness of the core layer is in a range of from about 35 to about 73% of the total thickness of the multilayer film. For example, a multilayer film might have an overall thickness of 30 μm, with a 22 μm core layer and 4 μm first and second outer layers on either side of the core layer. In another example, for a thicker film, a multilayer film might have an overall thickness of 50 μm, with a 34 μm core layer and 7 μm first and second outer layers on either side of the core layer. In still another example, for a very thin film, a multilayer film might have an overall thickness of 5 μm, with a 2 μm core layer and 1.5 μm first and second outer layers on either side of the core layer. In one embodiment, the thickness of the core layer is in a range of from about 55 to about 73% of the total thickness of the multilayer film. Those skilled in the art will appreciate that a minimum thickness of the outer layers with thermoplastic polyimide is needed to provide sufficient adhesion when laminated to other layers. In addition, a minimum thickness of the core layer is needed to maintain the mechanical integrity of the multilayer film. Methods to determine the thickness of each layer include mechanical preparation of cross sections together with microscopy-assisted optical evaluation using, for example, a scanning electron microscope.

In one embodiment, the first thermoplastic polyimide and the second thermoplastic polyimide of the multilayer film both have a T_{g} in the range of from about 140 to about 320° C. In a specific embodiment, the first thermoplastic polyimide and the second thermoplastic polyimide of the multilayer film both have a T_{g} in the range of from about 160 to about 300° C. In a more specific embodiment, the first thermoplastic polyimide and the second thermoplastic polyimide of the multilayer film both have a T_{g} in the range of from about 180 to about 280° C. Having thermoplastic polyimides in the outer layers with a higher T_{g} improves the thermal durability of the multilayer film. Laminates may undergo post-lamination processes such as hot-bar processing or spot welding at temperatures sometimes in excess of 300° C. Under these conditions, a low T_{g} thermoplastic polyimide layer is susceptible to adhesion loss and delamination, distortion, and blistering.

In one embodiment, the first thermoplastic polyimide and the second thermoplastic polyimide of the multilayer film are each individually derived from an aromatic dianhydride selected from the group consisting of 4,4′-oxydiphthalic dianhydride, pyromellitic dianhydride, 3,3′,4,4′-biphenyl tetracarboxylic dianhydride, 3,3′,4,4′-benzophenone tetracarboxylic dianhydride and mixtures thereof; and an aromatic diamine selected from the group consisting of 1,3-bis(4-aminophenxoxy)benzene, hexamethylene diamine, 2,2-bis-(4-[4-aminophenoxy]phenyl) propane and mixtures thereof. In one embodiment, the first thermoplastic polyimide and the second thermoplastic polyimide of the multilayer film are each individually derived from an aromatic dianhydride comprising 4,4′-oxydiphthalic dianhydride and pyromellitic dianhydride; and an aromatic diamine comprising 1,3-bis(4-aminophenxoxy)benzene.

In one embodiment, the core layer has a T_{g} exceeding 320° C. In a more specific embodiment, the core layer has a T_{g} exceeding 340° C. In another specific embodiment, the core layer has no detectable T_{g} below 375° C.

In one embodiment, the core layer and the outer layers can be simultaneously solution cast by co-extrusion. At the time of casting, the polyimides can be in the form of a polyamic acid solution. The cast solutions form an uncured polyamic acid film that is later cured to a polyimide. The adhesion strength of such laminates can be improved by employing various techniques for elevating adhesion strength.

In some embodiments, a finished polyamic acid solution is filtered and pumped to a slot die, where the flow is divided in such a manner as to form the first outer layer and the second outer layer of a three-layer coextruded film. In some embodiments, a second stream of polyimide is filtered, then pumped to a casting die, in such a manner as to form the middle polyimide core layer of a three-layer coextruded film. The flow rates of the solutions can be adjusted to achieve the desired layer thickness.

In some embodiments, the multilayer film is prepared by simultaneously extruding the first outer layer, the core layer and the second outer layer. In some embodiments, the layers are extruded through a single or multi-cavity extrusion die. In another embodiment, the multilayer film is produced using a single-cavity die. If a single-cavity die is used, the laminar flow of the streams should be of high enough viscosity to prevent comingling of the streams and to provide even layering. In some embodiments, the multilayer film is prepared by casting from the slot die onto a moving stainless-steel belt. In one embodiment, the belt is then passed through a convective oven, to evaporate solvent and partially imidize the polymer, to produce a “green” film. The green film can be stripped off the casting belt and wound up. The green film can then be passed through a tenter oven to produce a fully cured polyimide film. In some embodiments, during tentering, shrinkage can be minimized by constraining the film along the edges (i.e., using clips or pins).

In one embodiment, the outer layers of the present invention can also be applied to the core layer during an intermediate manufacturing stage of making polyimide film such as to gel film or to green film.

The term “gel film” refers to a polyamic acid sheet, which is laden with volatiles, primarily solvent, to such an extent that the polyamic acid is in a gel-swollen, or rubbery condition, and may be formed in a chemical conversion process. The volatile content is usually in the range of 70 to 90% by weight and the polymer content usually in the range of 10 to 30% by weight of the gel film. The final film becomes “self-supporting” in the gel film stage. It can be stripped from the support on which it was cast and heated to a final curing temperature. The gel film generally has an amic acid to imide ratio between 10:90 and 50:50, most often 30:70.

The gel film structure can be prepared by the method described in U.S. Pat. No. 3,410,826 A. This patent discloses mixing a chemical converting agent and a catalyst, such as a lower fatty acid anhydride and a tertiary amine, into the polyamic-acid solution at a low temperature. This is followed by casting the polyamic-acid solution in film-form, onto a casting drum. The film is mildly heated after casting, at, for example, 100° C., to activate the conversion agent and catalyst in order to transform the cast film to a polyamic acid/polyimide gel film.

Another type of polyimide film is a “green film” which is partially polyamic acid and partially polyimide, and may be formed in a thermal conversion process. Green film contains generally about 50 to 75% by weight polymer and 25 to 50% by weight solvent. Generally, it should be sufficiently strong to be substantially self-supporting. Green film can be prepared by casting the polyamic acid solution into film form onto a suitable support such as a casting drum or belt and removing the solvent by mild heating at up to 150° C. A low proportion of amic acid units in the polymer, e.g., up to 25%, may be converted to imide units.

Application of the polymer films of the present invention can be accomplished in any number of ways. Such methods include using a slot die, dip coating, or kiss-roll coating a film followed by metering with doctor knife, doctor rolls, squeeze rolls, or an air knife. The coating may also be applied by brushing or spraying. By using such techniques, it is possible to prepare both one and two-sided coated laminates. In preparation of the two-side coated structures, one can apply the coatings to the two sides of a polyimide either simultaneously or consecutively before going to the curing and drying stage of the polyimide.

In one embodiment, an individual polymer layer or the overall polymer multilayer film has a coefficient of thermal expansion (CTE) of less than 70 ppm/° C. (average of machine and transverse values), less than 40 ppm/° C., or less than 30 ppm/° C., over a temperature in the range of from 50 to 250° C. Thermoplastic polymer layers and the core layer in a multilayer film may have different CTE values (when evaluated separately as stand-alone films). In one embodiment, the CTE value of a core layer in a multilayer film is lower than those of the thermoplastic polymer layers (when evaluated separately as stand-alone films). In one embodiment, the core layer has a coefficient of thermal expansion of less than 70 ppm/° C. (average of machine and transverse values), less than 40 ppm/° C., or less than 30 ppm/° C., over a temperature range of 50 to 250° C. Keeping a low CTE over a broad temperature enables the multilayer film to maintain good adhesion even during higher temperature curing, which may be used to stabilize materials that will be subjected to higher temperature post-lamination processing. Laminates may undergo hot-bar processing or spot welding at temperatures sometimes in excess of 300° C. Under these conditions, a multilayer film with a high CTE is susceptible to adhesion loss and delamination, distortion, and blistering. Suitable methods to determine CTE include measurements performed using a thermomechanical analyzer (TMA) as, for example, described in ASTM D3386. In one embodiment, the multilayer film has a CTE that is close to the CTE of a flexible mat layer (described below). Matching CTEs between a multilayer film and a flexible mat layer will minimize the risk of distortion, wrinkling, and curl when combining such layers into a laminate structure.

### Flexible Mat Layers

In one embodiment, a first flexible mat layer includes a first organic material thermally bonded to the flexible polymer layer, wherein the first organic material includes a woven, a non-woven or a fiber. The first organic material can include 35 to 75 wt % of a first binder and 25 to 65 wt % of a first aramid floc, based on the total amount of first binder and first floc in the first flexible mat layer. In some embodiments, the first organic material includes 40 to 60 wt % of a first binder and 40 to 60 wt % of a first aramid floc, based on the total amount of first binder and first floc in the first flexible mat layer. In some embodiments, the first flexible mat layer has more binder than floc.

The use of this first flexible mat layer provides higher mechanical strength to the electrically insulating laminate structure, which is desirable when it is used in electric machine applications. On an equal weight basis, a multilayered structure, comprising the first flexible mat layer, has superior mechanical strength when compared to a structure having only the flexible polymer layer. Preferably, the first flexible mat layer is free of, or essentially free of, any inorganic filler. As used herein, “essentially free” means the first flexible mat layer functions thermally and mechanically as though no inorganic filler is present in the layer, even if some trace amounts of inorganic filler contamination are present in that layer. In one embodiment, a binder(s) can be any chemical or treatment or additive known in the art to bind floc or fibrous material to form a paper, in one embodiment the binder is a binder particle, such as a particle having a filmy structure. In one embodiment, the binder particle can be a fibrid, such as an aramid fibrid.

The term “floc”, as used herein, means fibers that are cut to a short length and that are customarily used in the preparation of wet-laid sheets and/or papers. Typically, floc has a length of from about 3 to about 20 mm. In one embodiment, floc has a length of from about 3 to about 7 mm. Floc is normally produced by cutting continuous fibers into the required lengths using well-known methods in the art.

The term “aramid”, as used herein, means aromatic polyamide, wherein at least 85% of the amide (—CONH—) linkages are attached directly to two aromatic rings. Optionally, additives can be used with the aramid and may be dispersed throughout the polymer structure. It has been found that up to as much as about 10 percent by weight of other polymeric material can be blended with the aramid. It has also been found that copolymers can be used having as much as about 10 mol % of other diamines substituted for the diamine of the aramid or as much as about 10 mol % of other diacid chlorides substituted for the diacid chloride of the aramid.

In one embodiment, an aramid is a meta-aramid. An aramid polymer is considered a meta-aramid when the two rings or radicals are meta oriented with respect to each other along the molecular chain. In one embodiment, a meta-aramid is poly(meta-phenylene isophthalamide) (MPD-I). U.S. Pat. Nos. 3,063,966 A, 3,227,793 A, 3,287,324 A, 3,414,645 A, and 5,667,743 A are illustrative of useful methods for making aramid fibers that could be used to make aramid floc.

Alternatively, the aramid floc could be a para-aramid or an aramid copolymer. The aramid polymer is considered a para-aramid when the two rings or radicals are para oriented with respect to each other along the molecular chain. Methods for making para-aramid fibers are generally disclosed in, for example, U.S. Pat. Nos. 3,869,430 A, 3,869,429 A, and 3,767,756 A. In one embodiment, a para-aramid is poly(paraphenylene terephthalamide). In one embodiment, a para-aramid copolymer is copoly(p-phenylene/3,4′diphenyl ester terephthalamide).

In one embodiment, an aramid floc is a meta-aramid floc, such as a floc made from the meta-aramid poly(meta-phenylene isophthalamide) (MPD-I).

The term “fibrids”, as used herein, means very small, nongranular, fibrous or film-like particles with at least one of their three dimensions being of minor magnitude relative to the largest dimension. These particles are prepared by precipitation of a solution of polymeric material using a non-solvent under high shear. Aramid fibrids are non-granular film-like particles of aromatic polyamide having a melting point or decomposition point above 320° C. The preferred aramid fibrid is a meta-aramid fibrid, and especially preferred are fibrids made from the meta-aramid poly(meta-phenylene isophthalamide) (MPD-I). Aramid fibrids can be made as generally described in U.S. Pat. No. 3,756,908 A.

Fibrids generally have a largest dimension length in the range of about 0.1 mm to about 1 mm with a length-to-width aspect ratio of about 5:1 to about 10:1. The thickness dimension is on the order of a fraction of a micron, for example, about 0.1 μm to about 1.0 μm. While not required, it is possible to incorporate aramid fibrids into the layers while the fibrids are in a never-dried state.

The term “flexible mat layer”, as used herein, refers to a thin planar material of a specific composition sometimes described as a “paper”. Paper can be made as generally described in U.S. Pat. Nos. 9,844,928 B2, 10,173,403 B2 and 10,836,112 B2.

In one embodiment, a flexible mat layer has a thickness of 0.5 mm or less, 0.25 mm or less, 0.13 mm or less, or 0.1 mm or less. It is believed that an individual flexible mat layer should have a thickness of at least 0.025 mm to provide adequate tensile strength to the electrically insulating laminate. Examples of flexible mat layer products are DuPont™ Nomex® papers (available from DuPont de Nemours Inc., Wilmington, DE).

In one embodiment, a flexible mat layer has a dielectric strength in a range of from 400 to 800 V/mil, when measured following the procedure described in ASTM D149. In one embodiment, a flexible mat layer has a dielectric constant in a range of from 1.5 to 4.0, when measured at 60 Hz following the procedure described in ASTM D150. In one embodiment, a flexible mat layer has desirable mechanical properties including high tensile strength in a range of from 40 to 200 N/cm in the machine direction (MD) and 5 to 20 N/cm in the transverse direction (TD), and elongation to break in a range of from 10 to 25% in MD and 5 to 20% in TD, when measured following the procedure described in ASTM D828. In one embodiment, a flexible mat layer has a thermal class H rating.

In one embodiment, a flexible mat layer has a T_{g} exceeding 320° C. In a more specific embodiment, the flexible mat layer has a T_{g} exceeding 340° C. In another embodiment, the flexible mat layer has a T_{g} exceeding 360° C.

In one embodiment, a flexible mat layer can be plasma-treated by passing it through an inner electrode type low-temperature plasma treatment apparatus described in Japanese Patent No. 4607826 B2. The composition ratio of the number of oxygen atoms (O) to the number of carbon atoms (C) in the plasma-treated surface of the material exceeds 150% relative to the theoretical value of the ratio of the numbers of the atoms before treatment.

### Production of Electrically Insulating Laminates

In one embodiment, the flexible mat layer is arranged on one or both sides of the electrically insulating laminate, and the polymer film is arranged as a core layer of the laminate. The flexible mat layer ensures satisfactory electrical insulation, chemical stability (chemical resistance), mechanical stability, and heat resistance while the polymer film ensures not only satisfactory chemical stability and heat resistance, but also additional electrical insulation and gas-liquid impermeability. The individual layers can be laminated together by any of the methods commonly used in the field that are able to exert temperature and pressure on the materials to be laminated during the process. In one embodiment, methods for forming the electrically insulating laminate include heating, pressing, heating under pressure, and the like. Examples of these methods include a method based on hot pressing, a method of passing between a pair of heated rolls or belts, a method using hot air, joining by ultrasonic, and the like, but are not limited thereto. Here, it is desirable to raise the temperature for forming the laminate over the T_{g} of the polymer layer (or an individual thermoplastic polyimide layer in case of a multilayer polyimide film), but not to raise the temperature for forming the laminate to a temperature near the melting point or the decomposition temperature of any of the layers, but to set the temperature lower than these temperatures. In one embodiment, the temperature used to form the laminate does not exceed the glass transition temperature of the polymer layer (or an individual thermoplastic polyimide layer in case of a multilayer polyimide film) by more than 150° C.

The dimensions of the flexible mat layer and the polymer film are not limited to particular sizes. The sizes to be used may be determined in consideration of various factors such as the application of the electrically insulating laminate, the production cost, and existing equipment limitations. From the standpoint of productivity, a roll of flexible mat layer and a roll of polymer film are prepared, and the laminate is manufactured by using a continuous heating and pressurizing process. In manufacturing of a prototype or a custom order item, the manufacturing can be made simpler by using the flexible mat layer and the polymer film of small sizes.

The heating and pressurizing process refers to a process of applying both of heat and pressure to the laminate. Although an apparatus which performs the heating and pressurizing process is not limited to a particular apparatus, a calender apparatus is used in one embodiment. The calender apparatus is widely used in the industry field and is an apparatus which is formed by combing several calender rolls and which applies compression force to a sheet target by passing the target between the rolls. Passing the target between the calender rolls can increase the density of the target and improve the smoothness of the target. Rolls having an appropriate size and made of an appropriate material such as steel rolls and elastic rolls are selected depending on the conditions of the pressure and temperature to be applied to the target. The configuration of the calender rolls is not limited to a particular configuration. A laminate in which different materials are laminated together can be manufactured by passing multiple sheet targets between the calender rolls. An appropriate calender apparatus is selected depending on the dimensions of sheets to be laminated. For example, when the flexible mat layer and the polymer film to be laid one on top of the other have long lengths and are in a rolled form, a calender apparatus with a paper sending function for two or more rolls may be used.

In one embodiment, the flexible mat layer and the polymer film are directly laminated to each other without an additional adhesion layer therebetween. In this mode, it is possible to reduce the manufacturing cost and improve productivity. In the present invention, an electrically insulating laminate with a sufficient bonding property can be manufactured without the presence of an adhesion layer. Methods to determine the absence of additional adhesion layers include mechanical preparation of cross sections together with microscopy-assisted optical evaluation using, for example, a scanning electron microscope, or mechanical-based evaluation, for example, using nanoidentation.

In one embodiment, bonding surfaces of the flexible mat layer and the polymer film are not plasma-treated before the heating and pressurizing process. Although the bonding property can be improved by plasma-treating the bonding surfaces, in the present invention an electrically insulating laminate with a sufficient bonding property can be manufactured without the plasma treatment. Employing a process of manufacturing the laminate without the plasma treatment can reduce manufacturing cost and improve productivity.

The temperature in the heating and pressurizing process is set to at least the glass transition temperature of the polyimide material forming the laminate. When the heating and pressurizing process is performed by using the calender rolls, the temperature of the calender rolls is set to at least the glass transition temperature of the polyimide forming the laminate.

In one embodiment, a temperature in a range of from 200 to 360° C. can be used in the heating and pressurizing process. In a specific embodiment, a temperature in a range of from 240 to 340° C. or 260 to 320° C. can be used. The temperature in the heating and pressurizing process can be generally adjusted by using a control mechanism of a used apparatus. For example, the temperature of a heat and pressure application device such as the calender rolls can be controlled as a set temperature of the calender rolls.

In one embodiment, in addition to the aforementioned specific temperature, a pressure in a range of from 400 to 800 psi (2758 to 5516 kPa) can be used in the heating and pressurizing process. In a specific embodiment, a pressure in a range of from 450 to 750 psi (3103 to 5171 kPa), 500 to 700 psi (3447 to 4826 kPa), or 525 to 675 psi (3620 to 4654 kPa) can be used. The pressure in the heating and pressurizing process can be generally adjusted by using the control mechanism of the used apparatus. For example, the pressure of the heat and pressure application device such as the calender rolls can be generally controlled by using the control mechanism of the apparatus.

In one embodiment of an electrically insulating laminate, a composition ratio of the number of oxygen atoms (O) to the number of carbon atoms (C) on the surface of the first thermoplastic polyimide layer is different by less than 1% when compared to the same ratio found within the bulk of the first thermoplastic polyimide layer. In one embodiment, a composition ratio of the number of oxygen atoms (O) to the number of carbon atoms (C) on the surface of the first organic material is different by less than 1% when compared to the same ratio found within the bulk of the of the first organic material.

In one embodiment of an electrically insulating laminate, each of the flexible polymer layer and the first flexible mat layer has a thermal class rating of at least H. In one embodiment of an electrically insulating laminate, the flexible polymer layer has a dielectric strength of at least 5000 V/mil and the first flexible mat layer has a dielectric strength of at least 400 V/mil. In one embodiment of an electrically insulating laminate, the peel strength between the flexible polymer layer and the first flexible mat layer is at least 0.100 N/mm.

Electrically insulating laminates of the present invention are useful in electric machine, for instance as slot liners for stators and rotors, such as generators and motors, providing electrical insulation between the stator core and/or rotor core and the stator windings and/or rotor windings. Slot liners will similarly separate rotor windings from the rotor core. In one embodiment, the electrically insulating laminates are used as slot liners in folded sheet form. In another embodiment, the electrically insulating laminates are used as slot liners in tubular form, more preferably as a multilayer spiral tube produced without layers overlap, i.e., the thickness of the tube around its perimeter is uniform throughout.

### EXAMPLES

### Test Methods

### Peel Strength

Peel strength results were obtained using an Instron 180° T-peel test. Laminate samples were 1″ wide, with 2″ initial grip separation, and evaluated using a 12 in/min cross head speed. The maximum load observed after extension by 3 inches was achieved was reported. The numerical average of 5 independent samples was reported.

### Glass Transition Temperature

Glass transition temperature (T_{g}) of individual materials was measured following test method IPC-TM-650 using dynamic mechanical analysis (Q800 DMA, TA Instrument, New Castle, DE). The test specimens were conditioned at 23° C. and 50% relative humidity for not less than 24 hours prior to testing. Heat was applied at a rate of 5° C./min in dry air, and the value of the first tan delta peak was reported unless noted otherwise.

For selected samples, glass transition temperature (T_{g}) of individual materials was measured using differential scanning calorimetry using the method as described in U.S. Pat. No. 10,836,112 B2.

### Thermal Conductivity

Thermal conductivity was measured according to the method described in ASTM D5470, at 50° C. and 150 psi without use of oil. 1, 2, and 4 layers of material were used.

### Tensile Test

Tensile tests, which allow the determination of mechanical properties such as elongation to break, tensile strength, elastic modulus etc., were performed according to ASTM D882.

### Coefficient of Thermal Expansion

Tests were performed according to ASTM D3386. Reported results are the average of CTE observed in both transverse (TD) and machine direction (MD).

### Example 1

For Example 1 (E1), to prepare a polyamic acid solution with a monomer composition of BPDA 0.9/BTDA 0.1//RODA 0.25/HMD 0.75, 0.05 mole of the diamines were dissolved in DMAc and agitated with a mechanical stirrer under nitrogen. Stirring was continued and 0.05 moles of the dianhydrides were added as solids over a short period of time. The polyamic acid solution, approximately 20 wt % solids, was decanted and later finished by incrementally adding a 6 wt % solution of pyromellitic dianhydride (PMDA) in DMAc to obtain a maximum viscosity of 2500-3000 poise. Using a stainless-steel casting rod, the polymer mixture was manually cast onto a glass plate and placed onto a hot plate set at 80° C. The film was heated until it could be peeled from the glass plate and transferred onto a pin frame. The film was then imidized by heating in an oven, ramping the temperature from 100° C. to approximately 20° C. above the glass transition temperature of the final polyimide film. The film was then removed from the oven, allowed to cool to ambient temperature, and subsequently removed from the pin frame. A polyimide film of thickness approximately 25 μm and a glass transition temperature of 199° C. was thus obtained.

### Example 2

For Example 2 (E2), a first polyamic acid solution “A” of a monomer composition of ODPA 0.8/PMDA 0.2//RODA 0.7/HMD 0.3 was prepared by following the procedure as described above for E1. A second polyamic acid solution “B” of a monomer composition of BPDA 0.9/PMDA 0.1//PPD 0.9/ODA 0.1 was prepared by following the procedure as described above for E1. Both polyamic acid solutions were co-cast on a stainless steel belt and then imidized by heating in an oven. A polyimide tri-layer A-B-A film having an overall thickness of approximately 25 μm was obtained. The glass transition temperature of layer A in the polyimide tri-layer A-B-A film was determined to be 210° C., and for layer B greater than 345° C. The thickness of layers A in the tri-layer film was on the order of 3 μm. The tri-layer film had a CTE of less than 30 ppm/° C.

### Example 3

For Example 3 (E3), a first polyamic acid solution “A” of a monomer composition of ODPA 0.8/PMDA 0.2//RODA 1.0 was prepared by following the procedure as described above for E1. A second polyamic acid solution “B” of a monomer composition of BPDA 0.35/PMDA 0.65//PPD 0.13/ODA 0.87 was prepared by following the procedure as described above for E1. Both polyamic acid solutions were co-cast on a stainless steel belt and then imidized by heating in an oven. A polyimide tri-layer A-B-A film of an overall thickness of approximately 25 μm was obtained. The glass transition temperature of layer A in the polyimide tri-layer A-B-A film was determined to be 235° C., and for layer B greater than 345° C. The thickness of layers A in the tri-layer film was on the order of 3 μm. The tri-layer film had a CTE of less than 30 ppm/° C.

### Example 4

For Example 4 (E4), to prepare a polyamic acid solution and make a polyimide film with a monomer composition of ODPA 0.8/PMDA 0.2//RODA 1.0, the procedure as described above for E1 was followed. A polyimide film of thickness approximately 25 μm and a glass transition temperature of 233° C. was thus obtained. The film had a CTE of less than 70 ppm/° C.

### Example 5

For Example 5 (E5), to prepare a polyamic acid solution and make a polyimide film with a monomer composition of ODPA 0.8/PMDA 0.2//RODA 1.0, the procedure as described above for E1 was followed. A polyimide film of thickness approximately 75 μm and a glass transition temperature of 240° C. was thus obtained. The film had a CTE of less than 70 ppm/° C.

### Example 6

For Example 6 (E6), a first polyamic acid solution “A” of a monomer composition of ODPA 0.8/PMDA 0.2//RODA 1.0 was prepared by following the procedure as described above for E1, and additionally incorporated 25 wt % of boron nitride as a filler (filler content relative to polyimide content in the final film). A second polyamic acid solution “B” of a monomer composition of PMDA//ODA was prepared by following the procedure as described above for E1, and additionally incorporated 50 wt % of boron nitride as a filler (filler content relative to polyimide content in the final film). Both polyamic acid solutions were co-cast on a stainless steel belt and then imidized by heating in an oven. A polyimide tri-layer A-B-A film of an overall thickness of approximately 38 μm was obtained. The glass transition temperature of layer A in the polyimide tri-layer A-B-A film was determined to be 232° C., and for layer B greater than 375° C. The thickness of layers A in the tri-layer film was on the order of 5 μm. The thermal conductivity of the final film was approximately 0.60 W/mK.

### Example 7

For Example 7 (E7), a first polyamic acid solution “A” of a monomer composition of ODPA 0.8/PMDA 0.2//RODA 1.0 was prepared by following the procedure as described above for E1. A second polyamic acid solution “B” of a monomer composition of PMDA//ODA was prepared by following the procedure as described above for E1. Both polyamic acid solutions were co-cast on a stainless-steel belt and then imidized by heating in an oven. A polyimide tri-layer A-B-A film of an overall thickness of approximately 25 μm was obtained. The glass transition temperature of layer A in the polyimide tri-layer A-B-A film was determined to be 228° C., and for layer B greater than 345° C. The thickness of layers A in the tri-layer film was on the order of 3 μm. The tri-layer film had a CTE of less than 70 ppm/° C.

### Example 8

For Example 8 (E8), a first polyamic acid solution “A” of a monomer composition of ODPA 0.8/PMDA 0.2//RODA 1.0 was prepared by following the procedure as described above for E1. A second polyamic acid solution “B” of a monomer composition of PMDA//ODA was prepared by following the procedure as described above for E1. Both polyamic acid solutions were co-cast under chemical curing conditions on a hot rotating drum and the resulting self-supporting film removed from the drum and then further dried and imidized by heating in an oven. A polyimide tri-layer A-B-A film of an overall thickness of approximately 25 μm was obtained. The glass transition temperature of layer A in the polyimide tri-layer A-B-A film was determined to be 228° C., and for layer B greater than 345° C. The thickness of layers A in the tri-layer film was on the order of 3 μm. The tri-layer film had a CTE of less than 40 ppm/° C.

### Comparative Examples 1 and 2

Comparative Examples 1 and 2 (CE1 and CE2) used a polyimide film Kapton® HA (DuPont) of composition PMDA//ODA, thickness 25 μm, and a glass transition temperature of greater than 375° C.

### Comparative Examples 3 and 4

Comparative Examples 3 and 4 (CE3 and CE4) used a polyimide film Kapton® HN (DuPont) of composition PMDA//ODA, thickness 25 μm, and a glass transition temperature of greater than 375° C.

### Comparative Examples 5 and 6

Comparative Examples 5 and 6 (CE5 and CE6) used a polyimide film Kapton® HN of composition PMDA//ODA, thickness 12.5 μm, and a glass transition temperature of greater than 375° C.

### Comparative Examples 7 and 8

For Comparative Examples 7 and 8 (CE7 and CE8), to prepare a polyamic acid solution and make a polyimide film with a monomer composition of BPDA 0.88/PMDA 0.12//ODA 0.5/PPD 0.95, the procedure as described above for E1 was followed. A polyimide film of thickness approximately 25 μm and a glass transition temperature of greater than 345° C. but less than 375° C. was thus obtained.

### Comparative Example 9

Comparative Example 9 (CE9) used a polyimide film Kapton® HN of composition PMDA//ODA, thickness 25 μm, and a glass transition temperature of greater than 375° C. The film was plasma treated on both sides (treatment time 30 seconds, power setting 100 W, gas type argon, chamber pressure 100 mtorr) and used within 24 hours after the treatment had been applied. Similarly, sheets of Nomex® Type 464 LAM were also plasma treated and used within 24 hours after the treatment had been applied.

### Comparative Example 10 (CE10)

Comparative Example 10 (CE10) used the polyimide film obtained in CE7CE8. The film was plasma treated on both sides (treatment time 30 seconds, power setting 100 W, gas type argon, chamber pressure 100 mtorr) and used within 24 hours after the treatment had been applied. Similarly, sheets of Nomex® Type 464 LAM were also plasma treated and used within 24 hours after the treatment had been applied.

### Comparative Example 11

Comparative Example 11 (CE11) used a polyimide film Kapton® H (DuPont-Toray Co., Japan) of composition PMDA//ODA, thickness 50 μm, and a glass transition temperature of greater than 375° C. Using DSC, no endothermic change could be observed in the film below 375° C. that would traditionally be associated with a glass transition temperature.

### Comparative Example 12

Comparative Example 12 (CE12) used a polyimide film Kapton® HA of composition PMDA//ODA, thickness 25 μm, and a glass transition temperature of greater than 375° C.

### Comparative Example 13

Comparative Example 13 used a polyimide film Kapton® HN of composition PMDA//ODA, thickness 25 μm, and a glass transition temperature of greater than 375° C.

### Comparative Example 14

Comparative Example 14 (CE14) used a polyimide film Kapton® HN of composition PMDA//ODA, thickness 12.5 μm, and a glass transition temperature of greater than 375° C.

### Electrically Insulating Laminates

Electrically insulating laminate tri-layer structures using the polyimide films prepared in example E1-E6 and Comparative Example CE1-CE14 were prepared, having a core layer of polyimide bonded to two outer layers of flexible mat. The thermoplastic polyimides, with glass transition temperatures ranging from approximately 199° C. to 240° C. were laminated to 50 μm aramid paper. In case of Examples E1-E5 and Comparative Examples CE1-CE11, Nomex® Type 464 LAM (DuPont) was used. Nomex® 464 LAM showed a glass transition temperature of approximately 275° C. by DSC. In case of example E6 and Comparative Examples CE12-CE14 Nomex® Type 410 (DuPont) was used. In case of examples E7 and E8 Nomex® Type 410 (DuPont) was used.

The individual films of the three-layer laminate structures were dried prior to lamination to reduce the moisture content to less than 3%. Subsequently the three-layer structures were laminated together using mirror finished steel platens with two buffer layers of 1.0 mil Kapton® HN (DuPont) using a hydraulic hot press at temperatures of 280° C., 300° C., and 320° C., respectively, and 625 psi to form the electrically insulating laminate. The Nomex® sheets were prepared with a 2″ extension in the machine direction relative to the polyimide layer in order to allow initiating the peel in the subsequent peel strength test. Peel strength and T_{g} values are shown in Table 1. “*” denotes that the interlaminar bond strength exceeded the tear strength of the material being pulled, to which a peel strength value of greater than 0.400 N/mm was assigned based on experimental observation.

TABLE 1

| | | | | T_{g} of | Polyimide |
|---|---|---|---|---|---|
| | Peel Strength (N/mm) | | | Polyimide | Thickness |
| Example | 280° C. | 300° C. | 320° C. | (° C.) | (μm) |
| E1 | 0.122 | 0.192 | * | 199 | 25 |
| E2 | 0.380 | * | * | 210 | 25 |
| E3 | 0.319 | 0.280 | * | 235 | 25 |
| E4 | 0.321 | * | * | 233 | 25 |
| E5 | 0.359 | 0.373 | * | 240 | 75 |
| E6 | * | — | * | 232 | 38 |
| E7 | | | | 228 | 25 |
| E8 | | | | 228 | 25 |
| CE1 | 0.023 | — | — | >375 | 25 |
| CE2 | — | — | 0.025 | >375 | 25 |
| CE3 | 0.025 | — | — | >375 | 25 |
| CE4 | — | — | 0.030 | >375 | 25 |
| CE5 | 0.023 | — | — | >375 | 12.5 |
| CE6 | — | — | 0.037 | >375 | 12.5 |
| CE7 | 0.030 | — | — | >345 | 25 |
| CE8 | — | — | 0.032 | >345 | 25 |
| CE9 | — | — | 0.081 | >375 | 25 |
| CE10 | — | — | 0.026 | >345 | 25 |
| CE11 | — | — | 0.077 | >345 | 50 |
| CE12 | — | — | 0.032 | >375 | 25 |
| CE13 | — | — | 0.032 | >375 | 25 |
| CE14 | — | — | 0.033 | >375 | 25 |

What is claimed is:

1. An electrically insulating laminate comprising:
a flexible polymer layer comprising a first thermoplastic polyimide having a glass transition temperature (T_{g}) in a range of from 140 to 280° C.; and
a first flexible mat layer comprising a first organic material, wherein:
the first organic material comprises a woven, a non-woven or a fiber; and
the flexible polymer layer is thermally bonded and in direct contact with the first organic material.

2. The electrically insulating laminate of claim 1, wherein the first organic material is selected from the group consisting of aramid paper, aramid fiber, and mixtures thereof.

3. The electrically insulating laminate of claim 1, further comprising a second flexible mat layer comprising a second organic material adhered to the flexible polymer layer on a side opposite the first flexible mat layer, wherein the second organic material comprises a woven, a non-woven or a fiber.

4. The electrically insulating laminate of claim 3, wherein the second organic material is selected from the group consisting of aramid paper, aramid fiber, and mixtures thereof.

5. The electrically insulating laminate of claim 1, wherein the first thermoplastic polyimide comprises:
an aromatic dianhydride selected from the group consisting of 4,4′-oxydiphthalic dianhydride, pyromellitic dianhydride, 3,3′,4,4′-biphenyl tetracarboxylic dianhydride, 3,3′,4,4′-benzophenone tetracarboxylic dianhydride and mixtures thereof; and
an aromatic diamine selected from the group consisting of 1,3-bis(4-aminophenxoxy)benzene, hexamethylene diamine, 2,2-bis-(4-[4-aminophenoxy]phenyl) propane and mixtures thereof.

6. The electrically insulating laminate of claim 1, wherein the flexible polymer layer further comprises:
a core layer comprising a polyimide adhered to the first thermoplastic polyimide; and
a second thermoplastic polyimide adhered to the core layer on a side opposite the first thermoplastic polyimide.

7. The electrically insulating laminate of claim 6, wherein the second thermoplastic polyimide comprises:
an aromatic dianhydride selected from the group consisting of 4,4′-oxydiphthalic dianhydride, pyromellitic dianhydride, 3,3′,4,4′-biphenyl tetracarboxylic dianhydride, 3,3′,4,4′-benzophenone tetracarboxylic dianhydride and mixtures thereof; and
an aromatic diamine selected from the group consisting of 1,3-bis(4-aminophenxoxy)benzene, hexamethylene diamine and mixtures thereof.

8. The electrically insulating laminate of claim 6, wherein the first thermoplastic polyimide and the second thermoplastic polyimide are the same or different.

9. The electrically insulating laminate of claim 6, wherein the core layer comprises:
an aromatic dianhydride selected from the group consisting of 3,3′,4,4′-biphenyl tetracarboxylic dianhydride, 4,4′-oxydiphthalic dianhydride, pyromellitic dianhydride, 3,3′,4,4′-benzophenone tetracarboxylic dianhydride, bisphenol A dianhydride, 1,2,5,6-naphthalene tetracarboxylic dianhydride, 1,4,5,8-naphthalene tetracarboxylic dianhydride, and 2,3,6,7-naphthalene tetracarboxylic dianhydride and mixtures thereof.

10. The electrically insulating laminate of claim 6, wherein the core layer comprises:
an aromatic diamine selected from the group consisting of p-phenylenediamine, 4,4′-diaminodiphenyl ether, 3,4′-diaminodiphenyl ether, 2,2′-bis(trifluoromethyl)benzidine, m-phenylenediamine and 4,4′-diaminodiphenylmethane.

11. The electrically insulating laminate of claim 1, wherein the flexible polymer layer contains an inorganic or organic filler or a mixture thereof.

12. The electrically insulating laminate of claim 6, wherein the core layer and both thermoplastic polyimide layers contain an inorganic or organic filler or a mixture thereof.

13. An electric machine comprising the electrically insulating laminate of claim 1.
